(19) United States
(12) Patent Application Publication
(10) Pub. No.: US 2011/0003127 A1
(43) Pub. Date: Jan. 6, 2011

(54) EDGE-FASTENING TAPE AND USE THEREOF

(75) Inventors: Yuki Saitou, Ibaraki-shi (JP); Kenichi Shibata, Ibaraki-shi (JP); Toshitaka Suzuki, Ibaraki-shi (JP)

Correspondence Address: J-TEK LAW PLLC, 601 Pennsylvania Avenue, NW, Suite 900, South Building, Washington, DC, 20004, US

(73) Assignee: NITTO DENKO CORPORATION, Ibaraki-shi (JP)

(21) Appl. No.: 12/920,959

(22) PCT Filed: Feb. 9, 2009
(86) PCT No.: PCT/JP2009/052178

§ 371 Date: Sep. 3, 2010

(30) Foreign Application Priority Data
Mar. 12, 2008 (JP) 2008-062588
Feb. 9, 2009 (JP) PCT/JP2009/052178

(51) Int. Cl. C09J 7/02; B32B 7/12; B32B 7/02; B32B 25/18; B32B 27/32; B29C 65/48

(52) U.S. Cl. 428/216; 428/353; 428/336; 156/304.5

(57) ABSTRACT

An edge-fastening tape (10) is provided that affixes an edge portion (20A) of a coating film protective sheet (20) to an adherend (30) having a coating film (32). The tape (10) has a rubber pressure-sensitive adhesive (PSA) layer (16) provided on one surface of a sheet-shaped support (12). An adhesive strength raising agent (14) that raises the adhesive strength of the PSA layer (16) with the passage of time is disposed between the PSA layer (16) and the support (12). The adhesive strength raising agent (14) is an acid-modified polyolefin resin that does not have a dominant endothermic peak corresponding to a softening temperature and/or a chlorinated polyolefin resin having a glass transition temperature below 10° C. in a DSC measurement.

### TECHNICAL FIELD

The present invention relates to an edge-fastening tape that affixes an edge portion of a coating film protective sheet and prevents the protective sheet from peeling off.

This application claims priority to Japanese Patent Application No. 2008-062588 filed on Mar. 12, 2008, the entire contents of which are incorporated herein by reference.

### BACKGROUND ART

A technique is known for protecting a coating film by bonding a protective sheet thereto with the objective of preventing the coating film surface from being damaged when an article having the coating film (for example, a painted automobile, parts thereof, metal plates such as steel plate, and molded products thereof) is transported, stored, cured or used for construction (referred to hereinbelow as “transported”). The coating film protective sheet used for such a purpose is generally configured to have a pressure-sensitive adhesive (PSA) layer on one side of a sheet-shaped substrate and the protection can be ensured by bonding the protective sheet via the PSA layer to an adherend surface (coating film that is the object of the protection). Examples of technical literature relating to coating film protective sheets of this type include Patent

### Document 1 and Patent Document 2.

Patent Document 1: Japanese Patent Application Publication No. 2001-240820

Patent Document 2: Japanese Patent Application Publication No. H9-3420

### DISCLOSURE OF THE INVENTION

However, when automobiles are transported by land, they are most often loaded on a carrier (transportation means), such as a truck or a freight train, and are transported in an uncovered state (exposed to the wind). In such a transportation mode, as the carrier travels at a high speed (generally at a speed of about 80 km/h to 100 km/h), the automobiles carried thereby are subjected to a strong wind pressure. As a result, a coating film protective sheet attached to the automobile (typical attachment zones include bonnets, roof, side panels and door portions of the automobile body) will sometimes flap in the wind and peel away from the coating film. In particular, because the goal has been to improve productivity and to improve the external appearance of the coating films, there has been a tendency in recent years to increase the amount of surface-adjusting agents used (additives that have the function of adjusting the surface state of the coating film, such as anti-foaming agents and leveling agents), which agents include a substance (adhesion inhibitor) having a low surface energy and/or a low molecular weight, such as organosilicones and acrylic oligomers, as the active ingredient. When a large amount of such adhesion inhibitors is present on the coating film surface, the probability of the coating film protective sheet peeling-off due to the wind pressure (wind resistance) increases because the adhesive strength readily decreases.

Increasing the adhesive strength of the PSA sheet is generally considered as a means for preventing the PSA sheet from peeling-off. However, in the field of coating film protective sheets (in particular, coating film protective sheets that are used for a relatively large surface area and cover the entire roof or bonnet of the automobile body), measures only intended to increase the adhesive strength of the protective sheet itself often result in reduced detachability when the coating film protective sheet, which is no longer needed for protection, is removed from the adherend.

Another means for preventing the coating film protective sheet from peeling-off involves preparing a PSA tape separately from the protective sheet and attaching the outer edge of the coating film protective sheet to the adherend by adhering the PSA tape (edge-fastening tape) so as to straddle the coating film protective sheet and the adherend. The edge-fastening tape used in such a manner is required to have an adhesive strength that is higher than the adhesive strength of the protective sheet itself so as to reliably prevent the coating film protective sheet from peeling-off during transportation. However, once an edge-fastening tape with a high adhesive strength has been affixed, it is difficult to re-adhere (rework). As a result, in particular when protecting a painted surface having a complex shape such as that of an automobile body, it is difficult to quickly and properly perform the task of affixing the outer edge of the coating film protective sheet using the edge-fastening tape.

It is an object of the present invention to provide a method that solves the above-described problems according to a different approach than improving the properties of the coating film protective sheet itself. Another object of the present invention is to provide a material that can be advantageously used in such a method.

The inventors have discovered that a coating film protective sheet can be prevented from peeling-off, while maintaining reworking properties during adhering, by using an edge-fastening tape that has a prescribed configuration, and this finding led to the creation of the present invention.

The present invention provides an edge-fastening tape that affixes an edge portion of a coating film protective sheet (can be referred to hereinbelow simply as a “protective sheet”), which has a PSA layer on a substrate, to an adherend (for example, a painted automobile or other vehicle body). The edge-fastening tape includes a sheet-shaped support and a rubber PSA layer provided on one surface of the support. An adhesive strength raising agent, which raises the adhesive strength of the PSA layer with the passage of time, is disposed between the PSA layer and the support. The adhesive strength raising agent is an acid-modified polyolefin resin (typically, a chlorine-free acid-modified polyolefin resin) that does not have a dominant endothermic peak corresponding to a softening temperature in a DSC measurement (differential scanning calorimetry) in which the temperature is raised from −10° C. to 200° C. at a rate of 10° C./min.

When the acid-modified polyolefin resin is disposed between the PSA layer and the support (initial position), no contribution is made to the adhesive strength of the PSA layer. Therefore, when the edge-fastening tape is affixed, a moderate (not too high) adhesive strength with a good reworking property can be exhibited due to the properties of the rubber PSA itself that is used to form the PSA layer. Further, acid-modified polyolefin resins, whose behavior in the DSC measurement satisfies the prescribed condition, have the property that at least part of the resin diffuses from the initial position into the rubber PSA layer with the passage of time (under a temperature condition that exceeds a normal temperature; for example, with the passage of time at 60° C. to 100° C.), and therefore can function effectively as an adhesive strength raising agent that raises the adhesive strength (for example, at least the high-speed peel strength) of the PSA layer. In other words, acid-modified polyolefin resins satisfying the above-described DSC characteristic excel in the ability to raise the adhesive strength of the PSA layer with the passage of time. Therefore, according the edge-fastening tape of the above-described configuration, it is possible to ensure both the good reworking property during adhering and a high adhesive strength after the passage of time (ability to prevent the coating film protective sheet from peeling-off).

The present invention provides a method for manufacturing an edge-fastening tape that affixes an edge portion of a coating film protective sheet, which has a PSA layer on a substrate, to an adherend. This method can include the step of selecting an acid-modified polyolefin resin, which does not have a dominant endothermic peak corresponding to a softening temperature in a DSC measurement in which the temperature is raised from −10° C. to 200° C. at a rate of 10° C./min, as an adhesive strength raising agent. The method can also include the step of disposing the acid-modified polyolefin resin on one surface of a sheet-shaped support (typically forming an adhesive strength raising agent layer that includes the acid-modified polyolefin resin as the main component). The method can also include the step of forming a rubber (preferably, polyisobutylene) PSA layer on the acid-modified polyolefin resin.

According to such a manufacturing method, it is possible to efficiently manufacture an edge-fastening tape that combines a good reworking property during adhering with a high adhesive strength after the passage of time. This manufacturing method can be advantageously used, for example, as a method for manufacturing the above-described edge-fastening tape.

A polyolefin resin including an acid-modified polyolefin chain that has been graft modified by an acid (typically, one, two or more acids selected from α,β-unsaturated carboxylic acids and anhydrides thereof, for example, maleic anhydride) can be advantageously used as the acid-modified polyolefin resin for the adhesive strength raising agent. The adhesive strength of the edge-fastening tape can be further increased with an adhesive strength raising agent having such a composition.

In a preferred mode, the weight-average molecular weight, when calculated as polystyrene, of the acid-modified polyolefin resin is approximately equal to or greater than 3×10⁴ (typically about 3×10⁴ to 20×10⁴). The adhesive strength of the edge-fastening tape can be further increased with an adhesive strength raising agent having such a composition, while suppressing the influence on other properties (for example, the reworking properties during adhering and adhesive residue properties at the time of peeling-off).

The present invention also provides an edge-fastening tape that affixes an edge portion of a protective sheet, which has a PSA layer on a substrate, to an adherend (for example, a painted automobile or other vehicle body). The edge-fastening tape includes a sheet-shaped support and a rubber PSA layer provided on one surface of the support. An adhesive strength raising agent, which raises the adhesive strength of the PSA layer with the passage of time, is disposed between the PSA layer and the support. The adhesive strength raising agent is a chlorinated polyolefin resin having a glass transition temperature (Tg) below 10° C. as determined by a DSC measurement in which the temperature is raised from −10° C. to 200° C. at a rate of 10° C./min.

Similar to the above-described acid-modified polyolefin resin, when a chlorinated polyolefin resin is disposed between the PSA layer and the support (initial position), no contribution is made to the adhesive strength of the PSA layer. Therefore, when the edge-fastening tape is adhered, a moderate (not too high) adhesive strength with a good reworking property can be demonstrated due to the properties of the rubber PSA itself that is used to form the PSA layer. Further, the behavior of the chlorinated polyolefin resins (may be an acid-modified chlorinated polyolefin resin) in the DSC measurement satisfy the prescribed condition. Chlorinated polyolefin resins exhibiting such a DSC characteristic have the property that at least part of the resin diffuses from the initial position into the rubber PSA layer with the passage of time, and therefore can function effectively as an adhesive strength raising agent that raises the adhesive strength (for example, at least the high-speed peel strength) of the PSA layer. In other words, chlorinated polyolefin resins satisfying the above-described DSC characteristic excel in the ability to raise the adhesive strength of the PSA layer with the passage of time. Therefore, according the edge-fastening tape of the above-described configuration, it is possible to ensure both a good reworking property during adhering and a high adhesive strength after the passage of time.

The present invention also provides a method for manufacturing an edge-fastening tape that affixes an edge portion of a coating film protective sheet, which has a PSA layer on a substrate, to an adherend. This method can include the step of selecting a chlorinated polyolefin resin, which has a glass transition temperature below 10° C. as determined by a DSC measurement in which the temperature is raised from −10° C. to 200° C. at a rate of 10° C./min, as an adhesive strength raising agent. The method can also include the step of disposing the chlorinated polyolefin resin on one surface of a sheet-shaped support (typically forming an adhesive strength raising agent layer that includes the chlorinated polyolefin resin as the main component). The method can also include the step of forming a rubber (preferably, polyisobutylene) PSA layer on the chlorinated polyolefin resin.

According to such a manufacturing method, it is possible to efficiently manufacture an edge-fastening tape that combines a good reworking property during adhering with a high adhesive strength after the passage of time. This manufacturing method can be advantageously used, for example, as a method for manufacturing the above-described edge-fastening tape.

In a preferred mode, the weight-average molecular weight, when calculated as polystyrene, of the chlorinated polyolefin resin is approximately equal to or greater than 3×10⁴ (typically about 3×10⁴ to 20×10⁴). The adhesive strength of the edge-fastening tape can be further increased with an adhesive strength raising agent having such a composition, while suppressing the influence on other properties (for example, the reworking properties during adhering and adhesive residue properties at the time of peeling-off).

In any of the edge-fastening tapes disclosed herein, it is preferred that the adhesive strength raising agent is disposed on the support surface (i.e., the surface on the side where the PSA layer will be provided) as a layer having a thickness of about 0.02 μm to 3 μm. The adhesive strength raising agent is effectively used with an edge-fastening tape having such a configuration and the adhesive strength can be sufficiently increased.

In any of the edge-fastening tapes disclosed herein, it is preferred that the support is constituted by a polyolefin resin sheet. The polyolefin resin sheet preferably includes solely a polypropylene resin (can be abbreviated hereinbelow as “PP resin”) as the resin component or includes a PP resin and a polyethylene resin (can be abbreviated hereinbelow as “PE resin”) as the resin components. A support having such a composition has advantageous properties as a support for an edge-fastening tape for affixing a protective sheet (for example, an automobile coating film protective sheet that is used in automobiles and parts thereof). A support having such a composition is also preferred from the standpoint of recyclability, etc.

In any of the edge-fastening tapes disclosed herein, it is preferred that the PSA layer is a polyisobutylene PSA layer. This is because a PSA layer having such a composition leaves hardly any adhesive residue on a coating film (for example, a coating film for an automobile) and does not leave tape traces on the coating film.

The present invention also provides a method for preventing a coating film protective sheet, which has a PSA layer on a substrate, from peeling off from the coating film when the protective sheet is adhered to the coating film on the adherend surface and is protecting the coating film. According to this method, an edge portion of the coating film protective sheet is affixed to the adherend by attaching any of the edge-fastening tapes disclosed herein so as to straddle the edge portion and the adherend.

According to another aspect of the present invention, a coating film protection method is provided that includes the steps of affixing (adhesively bonding) the coating film protective sheet to a coating film on an adherend surface and affixing an edge portion of the protective sheet to the adherend by adhering the edge-fastening tape so as to straddle the edge portion of the protective sheet and the adherend.

According to yet another aspect of the present invention, a method for transporting an article (adherend) having a coating film is provided. This method includes the steps of adhering a coating film protective sheet, which has a PSA layer on a substrate, to the coating film, affixing an edge portion of the protective sheet to the adherend by adhering the edge-fastening tape so as to straddle the edge portion of the protective sheet and the adherend, and transporting (preferably, transporting in a state in which the adherend is loaded on a carrier that moves at a relatively high speed, such as a truck or a freight train, and is exposed to the environment) the adherend that affixes the edge portion of the coating film protective sheet using the edge-fastening tape.

The edge-fastening tapes disclosed herein combine a good reworking property during adhering with a high adhesive strength after the passage of time. Therefore, according to the peeling prevention method, the coating film protection method and the transporting method, it is possible to effectively prevent the protective sheet from peeling off, for example, due to wind pressure during transportation, while ensuring good working properties when the coating film protective sheet is affixed using the edge-fastening tape.

### BRIEF DESCRIPTION OF THE DRAWINGS

FIG. 1 is a cross-sectional view schematically illustrating a configuration example of an edge-fastening tape in accordance with the present invention.

FIG. 2 is a schematic cross-sectional view exemplifying an application of an edge-fastening tape in accordance with the present invention.

FIG. 3 is a schematic plan view exemplifying an application of an edge-fastening tape in accordance with the present invention.

FIG. 4 is a DSC chart of the acid-modified polyolefin resin used in Example 1.

FIG. 5 is a DSC chart of the acid-modified polyolefin resin used in Example 2.

FIG. 6 is a DSC chart of the acid-modified polyolefin resin used in Example 3.

FIG. 7 is a DSC chart of the acid-modified polyolefin resin used in Example 5.

FIG. 8 is a DSC chart of the acid-modified polyolefin resin used in Example 6.

FIG. 9 is a DSC chart of the chlorinated polyolefin resin used in Example 7.

FIG. 10 is a DSC chart of the chlorinated polyolefin resin used in Example 8.

FIG. 11 is a DSC chart of the chlorinated polyolefin resin used in Example 9.

FIG. 12 is a DSC chart of the chlorinated polyolefin resin used in Example 11.

FIG. 13 is a DSC chart of the chlorinated polyolefin resin used in Example 12.

### BEST MODE FOR CARRYING OUT THE INVENTION

Preferred embodiments of the present invention will be described below. Technical matters necessary to practice the invention, other than those specifically referred to in the present description, may be understood as design matters for a person skilled in the art that are based on the related art in the pertinent field. The present invention may be practiced based on the contents disclosed herein and common general technical knowledge in the pertinent field.

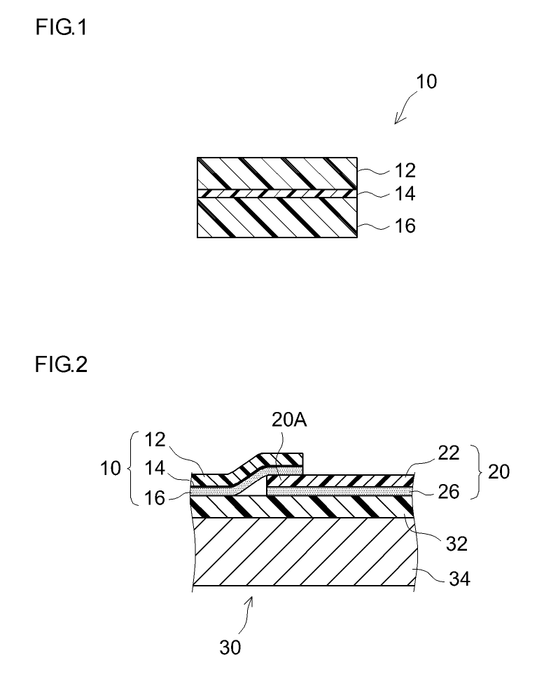

An edge-fastening tape for a protective sheet in accordance with the present invention (for example, an edge-fastening tape that affixes an edge portion of a coating film protective sheet used for protecting an automobile body) has a configuration in which a prescribed adhesive strength raising agent is disposed between a sheet-shaped support and a rubber PSA layer. For example, as shown schematically in FIG. 1, the edge-fastening tape 10 has a configuration in which an adhesive strength raising agent 14 is disposed as a layer on one surface of a support 12 and a PSA layer 16 is provided on the adhesive strength raising agent 14. In the edge-fastening tape 10 before it is used (that is, before it is adhered), at least a PSA surface of the PSA layer 16 (the adhesive surface, that is, the surface to be adhered to the object of the protection) can be protected by a release liner (not shown in the figure) serving as a peelable surface. In another possible configuration, the other surface (the back surface) of the support 12 is a peelable surface, the PSA layer 16 is brought into contact with the other surface and the surface thereof is protected by winding the edge-fastening tape 10 into a roll.

The support can be: a resin sheet based on a resin composition, for example, a polyolefin, a polyester and polyvinyl chloride (typically, a resin film obtained by molding a resin composition based on the above-described resin components); a foam substrate such as polyurethane foam and polyethylene foam; paper such as Kraft paper, crepe paper and Japanese paper; fabric such as cotton fabric and rayon fabric; nonwoven fabric such as polyester nonwoven fabric and vinylon nonwoven fabric; and metal foils such as aluminum foil and copper foil. A preferred mode is an edge-fastening tape having a polyolefin resin sheet as a support (that is, the resin component constituting the support is mainly a polyolefin resin). A support having such a composition is preferred from the standpoint of recyclability.

A polyolefin resin sheet (film), in which resin component(s) constituting the sheet is (are) mainly a PP resin (in other words, the resin components include a PP resin in excess of 50% by mass), can be advantageously used. For example, a resin sheet, in which a PP resin constitutes about 60% or more by mass (more preferably 75% or more by mass) of the resin components(s), is preferred. From the standpoint of heat resistance, a resin sheet, in which a continuous structure (continuous phase) is formed from a PP resin, can be advantageously used. A sheet that is substantially composed from one, two or more PP resins as the resin component(s) (that is, the resin component(s) include(s) only PP resin(s)), may be used. For example, an edge-fastening tape, in which a resin sheet having a continuous structure of a PP resin is used for the support, is advantageous because the edge-fastening tape is easily prevented from lifting-off from the adherend and/or a back surface of the protective sheet as a result of its thermal history, such as a temperature increase during outdoor curing. The support may have a single-layer structure or a multi-layer structure composed of two or more layers. In the case of a multi-layer structure, it is preferred that at least one layer has the aforementioned continuous structure of a PP resin.

Various polymers (propylene polymers) that include propylene as a component can be used as the PP resin for the support. The general concept of a propylene polymer, as referred to herein, is inclusive, for example, of the following: polypropylene.

A homopolymer of propylene (homopolypropylene). For example, isotactic polypropylene.

A random copolymer (random polypropylene) of propylene and another α-olefin (typically, one, two or more selected from ethylene and α-olefins having 4 to 10 carbon atoms). Preferably, a random polypropylene having propylene as the main monomer (main structural unit, that is, a component accounting for 50% or more by mass of all of the monomers). For example, a random polypropylene obtained by random copolymerization of propylene 96 to 99.9 mol % and the aforementioned other α-olefin (preferably ethylene and/or butene) 0.1 to 4 mol %.

A block copolymer (block polypropylene) including a copolymer (preferably a copolymer including propylene as the main monomer) obtained by block copolymerization of propylene and another α-olefin (typically, one, two or more selected from ethylene and α-olefins having 4 to 10 carbon atoms) and typically further including a rubber component that includes as a component at least one from among propylene and the aforementioned other α-olefins as a byproduct. For example, a block polypropylene including a polymer obtained by block copolymerization of propylene 90 to 99.9 mol % and the aforementioned other α-olefin(s) (preferably ethylene and/or butene) 0.1 to 10 mol % and additionally including a rubber component that includes as a component at least one from among propylene and the aforementioned other α-olefin(s) as a byproduct.

A PP resin for the support may be constituted substantially by one or several types of such propylene polymers (the aforementioned polypropylene or the like) or may be constituted by a thermoplastic olefin resin (TPO) or a thermoplastic elastomer (TPE) of a reactor blend type obtained by copolymerizing a large amount of a rubber component with the propylene polymer or a dry blend type obtained by mechanically dispersing the rubber component in the propylene polymer. Further, it may be a PP resin, which includes a copolymer of propylene and a monomer (monomer including a functional group) that includes another functional group in addition to a polymerizable functional group, or a PP resin in which such a monomer that includes a functional group is copolymerized with the propylene polymer.

When the polyolefin resin sheet includes another resin component in addition to the PP resin, a preferred example of the other resin component is a polyolefin resin (a PE resin having an ethylene polymer as the main component) having as the main component an olefin polymer that includes ethylene or an α-olefin with 4 or more carbon atoms as the main monomer. For example, a polyolefin resin sheet including a PE resin and a PP resin as the resin components can be advantageously used as the support for the edge-fastening tape disclosed herein.

High-density polyethylene and low-density polyethylene (high-density, medium-density and low-density polyethylene as stipulated by the old JIS K6748:1995) can be used as the PE resin for the support. Further, a PE resin including a copolymer of ethylene and another α-olefin (for example, an α-olefin having 3 to 10 carbon atoms) may be used. Preferred examples of the α-olefin include 1-butene, 1-hexene, 4-methyl-1-pentene and 1-octene. Further, a PE resin including a copolymer of ethylene and a monomer (monomer including a functional group), which has another functional group in addition to a polymerizable functional group, and a PE resin obtained by copolymerizing the monomer including a functional group with an ethylene polymer may be used. Examples of the copolymer of ethylene and a monomer that includes a functional group include an ethylene-vinyl acetate copolymer (EVA), an ethylene-acrylic acid copolymer (EAA), an ethylene-methacrylic acid copolymer (EMAA), an ethylene-methyl acrylate copolymer (EMA), an ethylene-ethyl acrylate copolymer (EEA), an ethylene-methyl methacrylate copolymer (EMMA) and an ethylene(meth)acrylic acid (that is acrylic acid and/or methacrylic acid) copolymer cross-linked using a metal ion. For example, low-density polyethylene (preferably straight-chain low-density polyethylene) or medium-density polyethylene having a density of equal to or less than 0.94 g/cm³ (typically 0.9 to 0.94 g/cm³) and ethylene-α-olefin copolymer having a density of 0.86 to 0.90 g/cm³ can be advantageously used as constituent components of the polyolefin resin sheet (preferably a resin sheet that includes a PE resin and a PP resin).

The resin sheet (preferably, a polyolefin resin sheet) used as the support of the edge-fastening tape disclosed herein can include, as necessary, an appropriate component that is allowed to be included in the support. For example, an additive such as a pigment (typically, an inorganic pigment), a filler, an antioxidant, a photostabilizer such as a radical trapping agent and a UV absorbent, a slip agent and an anti-blocking agent can be appropriately admixed.

Examples of materials that can be advantageously used as the pigment or filler include inorganic powers such as titanium oxide, zinc oxide and calcium oxide. The amount of the inorganic pigment or filler can be appropriately set taking into consideration the level of effect to be obtained by the addition and the moldability of the substrate acceptable for the resin sheet molding method (extrusion molding, cast molding, etc.). It is usually preferred that the amount (in case a plurality of types of additives are used, the total combined amount thereof) is about 2 to 20 parts by weight (more preferably about 5 to 15 parts by weight) per 100 parts by weight of the resin composition.

Examples of the antioxidants include compounds containing alkylphenols, alkylenebisphenols, esters of thiopropionic acid, organic phosphites, amines, hydroquinones and hydroxylamines as the active component(s). Examples of the photostabilizer include compounds containing benzotriazoles, hindered amines and benzoates as the active component(s). Such additives can be used individually or in combinations of two or more types thereof. The amount of the above-described additives in the support of the edge-fastening tape disclosed herein can be, for example, of the same order as the usual amount in the field of resin sheets that are used as substrates of protective sheets for coating films (typically, protective sheets for automobile coating films).

The resin sheet (preferably, a polyolefin resin sheet) can be manufactured by appropriately using a typical well-known conventional film molding method. For example, a method that extrusion molds a molding material, which includes the resin component(s) (preferably, resin component(s) that include(s) solely a PP resin or a PP resin as the main component and a PE resin as a secondary component) and an additive(s) that is (are) suitably admixed as necessary, can be advantageously used.

The surface of the support (typically a resin sheet) 12 shown in FIG. 1, on which the PSA layer 16 will be provided, may be subjected to a surface treatment such as acid treatment, corona discharge treatment, ultraviolet radiation irradiation treatment and plasma treatment. The surface (back surface) of the support 12, on the side opposite where the PSA layer 16 will be provided, may be subjected, if necessary, to a release treatment (for example, a treatment in which a typical silicone-based release agent, a long-chain alkyl-based release agent or a fluorine-based release agent is applied so as to obtain a thin film, typically having a thickness of about 0.01 μm to 0.1 μm). The effect produced by such a release treatment is that an edge-fastening tape 10, which has been wound into a roll, can be easily unwound.

The thickness of the support is appropriately selected according to the objective. Usually, a suitable thickness is about 20 μm to 100 μm, and a preferred thickness is about 30 μm to 70 μm (for example, about 35 μm to 60 μm). A support having such a thickness is advantageous for an edge-fastening tape of an automobile coating film protective sheet.

The width of the edge-fastening tape (typically this width is approximately equal to the width of the support) disclosed herein is, for example, about 0.5 cm to 20 cm, but is not particularly limited. An appropriate tape width is usually 1 cm to 10 cm and can be, for example, about 3 cm to 5 cm. An edge-fastening tape having such a width is preferred, for example, for an automobile coating film protective sheet.

The rubber-based PSA layer provided in the edge-fastening tape disclosed herein can be a PSA layer formed from a PSA composition that includes a variety of rubber polymers, such as natural rubber, styrene butadiene rubber (SBR), polyisobutylene, polyisoprene, styrene-isoprene block copolymer (SIS) and styrene-butadiene block copolymer (SBS) as the base polymer (the main component among the polymer components). In one preferred embodiment, the rubber-based PSA layer is a PSA layer formed from a PSA composition that includes an isobutylene polymer as the base polymer (polyisobutylene PSA layer). Polyisobutylene PSA is preferred because it exhibits a large solubility parameter (SP value) difference with the coating film (for example, an automobile coating film) and therefore material transfer between the two is unlikely, and because marks from adhering the edge-fastening tape (tape marks) to the coating film are unlikely. Such as PSA layer has a high elasticity modulus and is advantageous as a re-peelable PSA.

The isobutylene polymer may be an isobutylene homopolymer (homoisobutylene) or a copolymer that includes isobutylene as the main monomer. The copolymer can be, for example, a copolymer of isobutylene and normal butylene or a copolymer of isobutylene and isoprene (regular butyl rubber, chlorinated butyl rubber, bromated butyl rubber and partially cross-linked butyl rubber) and vulcanization or modification products thereof (for example, copolymers modified by a functional group such as a hydroxyl group, a carboxyl group, an amino group and an epoxy group). Homoisobutylene and an isobutylene-normal butylene copolymer are examples of isobutylene polymers that can be advantageously used due to the adhesive strength stability thereof (for example, the adhesive strength does not excessively increase with the passage of time or as a result of its thermal history). Among them, homoisobutylene is preferred.

The molecular weight of the isobutylene polymer is not particularly limited and a polymer with a weight-average molecular weight (Mw) of, for example, about 10×10⁴ to 150×10⁴ can be appropriately selected and used. Examples of the isobutylene polymer that can be advantageously used include isobutylene polymers with a Mw of about 20×10⁴ to 70×10⁴ (preferably, about 30×10⁴ to 60×10⁴, more preferably about 35×10⁴ to 50×10⁴).

The isobutylene polymer may be a peptized isobutylene polymer that is obtained by subjecting an isobutylene polymer of a higher molecular weight to a peptizing treatment in order to decrease the molecular weight thereof (preferably, to obtain the above-described preferred weight-average molecular weight). The peptizing treatment is preferably performed so as to obtain an isobutylene polymer having a Mw of about 10% to 80% of the Mw before the peptizing treatment. It is also preferred that the peptizing treatment is performed in order to obtain an isobutylene polymer with a number-average molecular weight (Mn) of about 10×10⁴ to 40×10⁴. Such a peptizing treatment can be implemented, for example, based on the disclosure of Japanese Patent No. 3878700.

The polyisobutylene PSA constituting the PSA layer can include one, two or more such isobutylene polymers as the base polymer. The polyisobutylene PSA can include a polymer other than polyisobutylene as a secondary component in addition to the base polymer. Examples of such polymers include poly(meth)acrylate, polybutadiene, polystyrene, polyisoprene, polyurethanes, polyacrylonitriles and polyamides. The content of these polymers, excluding the polyisobutylene, is preferably equal to or less than 10% by mass of all of the polymer components included in the polyisobutylene PSA. A PSA containing substantially no polymer other than polyisobutylene also may be used.

If necessary, various additives, for example, a tackifier, a softening agent, a pigment, a filler, an anti-aging agent, a photostabilizer (radical trapping agent, ultraviolet radiation absorber or the like) and other stabilizers can be admixed into the polyisobutylene PSA. Examples of the tackifier that can be advantageously used include alkylphenolic resins, terpenephenolic resins, epoxy resins, coumarone-indene resins, rosin resins, terpene resins and hydrogenation products thereof. Examples of the softening agent include process oil and a petroleum softening agent. Examples of materials that can be advantageously used as the pigment or filler include inorganic powders such as titanium oxide, zinc oxide, calcium oxide, magnesium oxide and silica. Examples of antioxidants include compounds containing alkylphenols, alkylenebisphenols, esters of thiopropionic acid, organic phosphites, amines, hydroquinones and hydroxylamines as the active component(s). Examples of the photostabilizer include compounds containing benzotriazoles, hindered amines and benzoates as the active component(s). Such additives can be used individually or in combinations of two or more types thereof. The amount of the above-described additives in the PSA for the edge-fastening tape disclosed herein can be, for example, of the same order as the usual amount in the field of PSA for coating film protective sheets (typically, automobile coating film protective sheets).

The thickness of the PSA layer is not particularly limited and can be appropriately determined according to the objective. Usually, an appropriate thickness is about 2 μm to 30 μm, preferably about 3 μm to 25 μm, and more preferably about 5 μm to 20 μm.

In the techniques disclosed herein, an adhesive strength raising agent that causes the adhesive strength of the PSA layer to rise with the passage of time (can be the passage of time under temperature conditions above the normal temperature) is disposed between the PSA layer and the support constituting the edge-fastening tape. One, two or more modified polyolefin resins selected from acid-modified polyolefin resins corresponding to (1) below and chlorinated polyolefin resins corresponding to (2) below can be used as the adhesive strength raising agent.

(1) An acid-modified polyolefin resin (preferably of a chlorine-free type; for example, a PP resin modified with maleic anhydride) that does not have a dominant endothermic peak corresponding to a softening temperature in a DSC measurement in which the temperature rises from −10° C. to 200° C. at a rate of 10° C./min. In other words, an acid-modified polyolefin resin for which heat absorption that accompanies the softening of the resin is not observed in the DSC measurement as one large peak that at least overwhelms other peaks (including the case in which the softening is accompanied by a broad endothermic peak and no distinct peak is observed, as well as the case in which the endothermic peak is a relative maximum, but is not overwhelmingly large as compared to the size of other peaks).

(2) A chlorinated polyolefin resin for which a glass transition temperature (Tg), which is determined by a DSC measurement in which the temperature rises from −10° C. to 200° C. at a rate of 10° C./min, is below 10° C. (typically, equal to or above −5° C. and below 10° C.). A chlorinated polyolefin resin having a Tg of equal to or below 5° C. (typically, equal to or above −5° C. and equal to or below 5° C.) is preferred.

The DSC measurement can be performed using a commercial DSC measurement device (for example, a differential scanning calorimeter, model DSC6220, manufactured by SII NanoTechnology Inc.). The measurement data are preferably values obtained by heating the sample from −10° C. to 200° C. at a temperature rising rate of 10° C./min, then rapidly cooling, and then again heating from −10° C. to 200° C. at a temperature rising rate of 10° C./min. The temperature rise can be started at a temperature below −10° C. (for example, −15° C., −50° C. or the like) and the temperature rise can be continued to a temperature above 200° C., provided that the heating is conducted at a temperature rise rate of 10° C./min at least within the temperature range from −10° C. to 200° C. Further, before the measurement data are acquired, it is preferred that the heating is limited to a range below about 250° C.

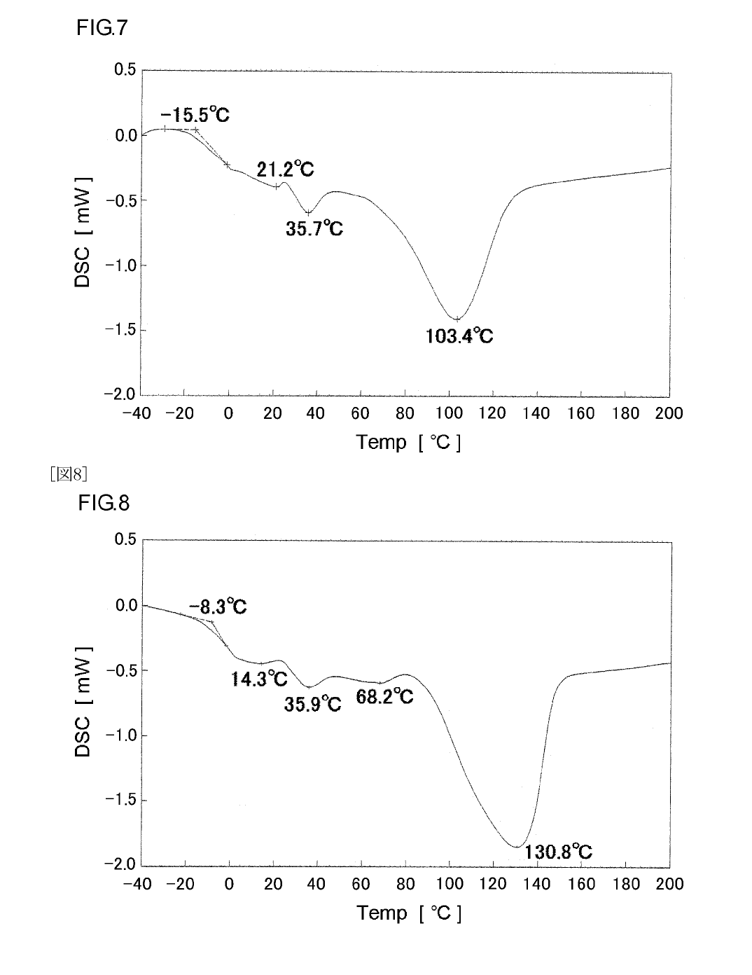

In an embodiment in which an acid-modified polyolefin resin corresponding to (1) above is used as the adhesive strength raising agent, an edge-fastening tape that exhibits a suitable adhesive strength acceptable for the work surface, thereby ensuring a good reworking property at the time of adhering and a high adhesive strength after the passage of time, can be realized by selecting a resin that has the above-described DSC characteristic from a variety of acid-modified polyolefin resins. An acid-modified polyolefin resin that does not have a dominant endothermic peak, not limited to a peak corresponding to the softening temperature, in the DSC measurement can be advantageously used. The adhesive strength (in particular, the high-speed peel strength) can greatly increase at an appropriate timing with the edge-fastening tape using an acid-modified polyolefin resin having such a DSC characteristic as the adhesive strength raising agent. On the other hand, because an acid-modified polyolefin resin, in which an endothermic peak corresponding to the softening temperature is exhibited as a dominant peak in the DSC measurement (see FIGS. 7 and 8), does not exhibit the effect of the substantial increase in adhesive strength in at least the usual usage mode (thermal history after attachment or the like) of the edge-fastening tape, it is not suitable as the adhesive strength raising agent in the techniques disclosed herein.

An appropriate acid-modified polyolefin resin can be used as the adhesive strength raising agent in the techniques disclosed herein, provided that the resin has the above-described DSC characteristic. The acid-modified polyolefin resin can have an acid-modified olefin polymer as the main component. An acid-modified polyolefin resin constituted essentially by an acid-modified olefin polymer may be also used. The olefin polymer (starting material) that will be modified by an acid is typically an olefin polymer having an α-olefin with about 2 to 10 carbon atoms as the main monomer. It may be an α-olefin homopolymer (polyethylene, polypropylene or the like), a copolymer of two or more α-olefins (ethylene-propylene copolymer, ethylene-propylene-butene copolymer or the like) or a copolymer of one, two or more α-olefins and another monomer. For example, an olefin polymer having propylene as the main monomer (the below-described homopolypropylene, random polypropylene, block polypropylene or the like) is preferred.

An acid-modified olefin polymer can be formed by treating (typically, grafting) the olefin polymer with an organic acid (preferably, α,β-unsaturated carboxylic acids) and/or anhydrides thereof As a result of such acid modification, the polyolefin chain constituting the olefin polymer is graft modified and an acid-modified polyolefin chain is formed. One, two or more acids selected from α,β-unsaturated carboxylic acids, for example, maleic acid, fumaric acid, itaconic acid, and acrylic acid, and anhydrides thereof, can be used for the acid modification. Preferred examples thereof include acrylic acid, acrylic anhydride and maleic anhydride.

The molecular weight of the acid-modified polyolefin resin (for example, an acid-modified PP resin) is not particularly limited and, for example, a resin with a Mw, when calculated as polystyrene, of about equal to or greater than 3×10⁴ (typically, about 3×10⁴ to about 20×10⁴) can be used. An acid-modified polyolefin resin with a Mw of about 3×10⁴ to 15×10⁴ is preferred, about 3×10⁴ to 10×10⁴ is more preferred, and about 3×10⁴ to 6×10⁴ is even more preferred. The cohesiveness of the PSA layer can easily decrease with the passage of time with an acid-modified polyolefin resin that has a Mw less than these values. The handling properties of the resin (for example, the manufacturing properties when the acid-modified polyolefin resin is disposed on the substrate surface) often tend to decrease with an acid-modified polyolefin resin that has a Mw higher than these values. An acid-modified polyolefin resin with a Mw/Mn ratio of about 3 to 8 (more preferably, about 5 to 7) can be advantageously used, but this ratio is not particularly limiting.

A resin of a chlorine-free type can be advantageously used as the acid-modified polyolefin resin. For example, it is preferred that an acid-modified polyolefin resin is used that is not modified by introduction of chlorine (chlorination or the like) or obtained by copolymerization of chlorine-containing monomer (typically, includes substantially no chlorine). An acid-modified polyolefin resin having a glass transition temperature (Tg) determined by the DSC measurement of equal to or below 30° C. (typically, −20° C. to 30° C., for example, 10° C. to 20° C.) can be advantageously used, but this range is not limiting. The adhesive strength can rise significantly at an appropriate timing in an edge-fastening tape that uses an acid-modified polyolefin resin having such a Tg as the adhesive strength raising agent.

Examples of commercial acid-modified polyolefin resins that can be advantageously used as the adhesive strength raising agent include chlorine-free acid-modified polyolefin resins manufactured by Nippon Paper Chemicals Co., Ltd. under the trade names “Auroren 100T”, “Auroren 150T” and “Auroren 150MX”.

In an embodiment in which a chlorinated polyolefin resin corresponding to (2) above is used as the adhesive strength raising agent, an edge-fastening tape that exhibits a suitable adhesive strength acceptable for the work surface, thereby ensuring a good reworking property at the time of adhering and a high adhesive strength after the passage of time, can be realized by selecting a resin that has the above-described DSC characteristic (typically, a chlorinated polyolefin resin that does not have a dominant endothermic peak corresponding to the softening temperature in the DSC measurement, preferably no dominant endothermic peak, not limited to a peak corresponding to the softening temperature) from a variety of chlorinated polyolefin resins. With an edge-fastening tape using a chlorinated polyolefin resin having such a DSC characteristic as the adhesive strength raising agent, the adhesive strength (in particular, the high-speed peel strength) can greatly increase at an appropriate timing. On the other hand, because a chlorinated polyolefin resin, in which the softening temperature determined in the DSC measurement is higher than the aforementioned value, does not exhibit the effect of the substantial increase in the adhesive strength in at least the usual usage mode (thermal history after attachment or the like) of the edge-fastening tape, it is not suitable as the adhesive strength raising agent in the techniques disclosed herein.

An appropriate chlorinated polyolefin resin can be used as the adhesive strength raising agent in the techniques disclosed herein, provided that the resin has the above-described DSC characteristic. The chlorinated polyolefin resin can have a chlorinated olefin polymer as the main component. A chlorinated polyolefin resin constituted essentially by a chlorinated olefin polymer may be also used. The olefin polymer (starting material) that is provided as the main monomer for the chlorination is typically an olefin polymer having an α-olefin with about 2 to 10 carbon atoms. It may be an α-olefin homopolymer (polyethylene, polypropylene or the like), a copolymer of two or more α-olefins (ethylene-propylene copolymer, ethylene-propylene-butene copolymer or the like) or a copolymer of one, two or more α-olefins and another monomer. For example, an olefin polymer having propylene as the main monomer (the below-described homopolypropylene, random polypropylene, block polypropylene or the like) is preferred. The method for chlorinating such an olefin polymer is not particularly limited, and a suitable method may be appropriately selected from various well-known methods. For example, a method of treating the olefin polymer with gaseous chlorine while heating can be advantageously used.

The content of the chlorine in the chlorinated polyolefin resin is not particularly limited. For example, a resin with a chlorine content of equal to or greater than 5% by mass (typically, about 5 to 60% by mass) can be used. Usually, a chlorinated polyolefin resin with a chlorine content of equal to or greater than about 10% by mass (typically, about 10 to 50% by mass), and a resin with a chlorine content of 20 to 40% by mass, is more preferred. The adhesive strength increasing effect often tends to decrease with a chlorinated polyolefin resin having a chlorine content less than or greater than this range. From the standpoint of environmental burden, it is also desirable that the use of a chlorinated polyolefin resin having a chlorine content greater than this range is avoided.

The molecular weight of the chlorinated polyolefin resin (for example, a chlorinated PP resin) is not particularly limited and, for example, a resin with a Mw, when calculated as polystyrene, of about equal to or greater than 3×10⁴ (typically, about 3×10⁴ to about 20×10⁴) can be used. A chlorinated polyolefin resin with a Mw of about 3×10⁴ to 15×10⁴ is preferred, more preferably about 3×10⁴ to 10×10⁴, and even more preferable about 3×10⁴ to 6×10⁴. The cohesiveness of the PSA layer can easily decrease with the passage of time with a chlorinated polyolefin resin having a Mw that is less than these values. The handling properties of the resin (for example, the manufacturing properties when said polyolefin resin is disposed on the substrate surface) often tend to decreases with a chlorinated polyolefin resin having a Mw that is greater than these values. A chlorinated polyolefin resin with a Mw/Mn ratio of about 3 to 8 (more preferably, about 5 to 7) can be advantageously used, but this ratio is not particularly limiting.

The chlorinated polyolefin resin that is used in the techniques disclosed herein may be an acid-modified chlorinated polyolefin resin. For example, it can be a chlorinated polyolefin resin subjected to acid modification by treating (typically, grafting) with an organic acid (preferably, α,β-unsaturated carboxylic acids) and/or anhydrides thereof. As a result of such acid modification, the polyolefin chain constituting the olefin polymer is graft modified and an acid-modified polyolefin chain is formed. One, two or more acids selected from α,β-unsaturated carboxylic acids, for example, maleic acid, fumaric acid, itaconic acid and acrylic acid, and anhydrides thereof, can be used for the acid modification. Preferred examples thereof include acrylic acid, acrylic anhydride and maleic anhydride.

Examples of commercial chlorinated polyolefin resin that can be advantageously used as the adhesive strength raising agent include chlorinated polyolefin resins manufactured by Toyo Kasei Kogyo Co., Ltd. under the trade names “Hardlen DX-526” and “Hardlen CY-9124”.

In a preferred mode of the edge-fastening tape disclosed herein, the adhesive strength raising agent is disposed on the support surface in the form of a layer. Various additives, for example, a pigment, a filler, an antioxidant, a photostabilizer (a radical trapping agent, an ultraviolet radiation absorbing agent or the like) and other stabilizers can be admixed, as necessary, with the adhesive strength raising agent layer. Additives similar to those that can be admixed with the support or the PSA can be used in commonly used amounts as the aforementioned additives. Alternatively, the adhesive strength raising agent layer may be constituted essentially by the acid-modified polyolefin resin corresponding to (1) above and/or the chlorinated polyolefin resin corresponding to (2) above.

The thickness of the adhesive strength raising agent layer is not particularly limited and can be appropriately determined within a range in which the desired adhesive strength raising effect is exhibited. The thickness of the adhesive strength raising agent layer can be, for example, about 0.01 μm to 30 μm, usually about 0.02 μm to 10 μm, and preferably about 0.02 μm to 3 μm, but these ranges are not particularly limiting. For example, an adhesive strength raising agent layer having a thickness within the above-described ranges can be advantageously used in an automobile coating film protective sheet. When the thickness of the adhesive strength raising agent layer is less than the aforementioned ranges, the effect of increasing the adhesive strength with the passage of time tends to decrease. The thickness of the adhesive strength raising agent layer may be about 0.5 μm to 3 μm (for example, about 1 μm to 2 μm), and such a thickness can significantly increase the adhesive strength. On the other hand, when the thickness of the adhesive strength raising agent layer is greater than the aforementioned ranges, adverse effects on other properties (cohesiveness or the like) can be readily produced.

The adhesive strength raising agent layer can be advantageously formed, for example, by preparing (manufacturing, purchasing or the like) a composition, in which the material forming the adhesive strength raising agent layer that includes the adhesive strength raising agent and additive(s) admixed as necessary, is dissolved or dispersed in an appropriate solvent, applying (typically, coating) the composition onto the support surface and drying. Alternatively, the adhesive strength raising agent layer may be formed by a method of heating and melting the material forming an adhesive strength raising agent layer, applying it onto the support surface and solidifying by cooling. The adhesive strength raising agent layer is typically formed continuously over the entire area that forms the PSA layer, but the adhesive strength raising agent layer may be also formed in a regular or random pattern, such as spots or stripes, in accordance with the objective and the application.

A rubber (for example, polyisobutylene) PSA layer can be formed according to the PSA layer formation method that is used for well-known PSA sheets. For example, a method (direct method) can be advantageously used in which a PSA composition is prepared (manufactured, purchased or the like), in which a material forming a PSA layer that includes a polymer component having a rubber (for example, isobutylene) polymer as the main component and additive(s) admixed as necessary, is dissolved or dispersed in an appropriate solvent and the PSA composition is directly applied (typically, coated) onto a support having the adhesive strength raising agent disposed thereon (for example, a substrate having the adhesive strength raising agent layer formed thereon) and drying, thereby forming a PSA layer on one surface of the substrate. Further, a method (transfer method) may be also used, in which the PSA composition is applied to a surface with good release properties, such as a release liner or a base surface of a substrate subjected to a release treatment, the applied PSA composition is dried to form a PSA layer on the surface, and the PSA layer is then transferred onto a support having the adhesive strength raising agent disposed thereon. The PSA layer is typically formed continuously, but it may be also formed in a regular or random pattern, such as spots or stripes, in accordance with the objective and the application.

When the PSA composition applied to the support using the direct method is dried, the drying can be accelerated, if necessary, by heating. A drying temperature of about 70 to 130° C. can be advantageously used, but this range is not particularly limiting.

The edge-fastening tape disclosed herein can be used for applications in which an edge portion of various well-known protective sheets for coating films is affixed to an adherend (an object that should be protected by the coating film protective sheet). The coating film protective sheet typically has a configuration in which a PSA layer is formed on a substrate. The substrate of the protective sheet can be formed from a material similar to that of the support of the edge-fastening tape disclosed herein. For example, a coating film protective sheet is preferred that has a substrate composed of a polyolefin resin sheet, which includes solely a polypropylene resin as the resin component or includes a polypropylene resin and a polyethylene resin as the resin components. Further, the PSA layer provided in the protective sheet can have a composition similar to that of the PSA layer of the edge-fastening tape disclosed herein. For example, a coating film protective sheet provided with a rubber (preferably, polyisobutylene) PSA layer is preferred. In contrast with the edge-fastening tape in accordance with the present invention, no adhesive strength raising agent is disposed in a typical configuration of the coating film protective sheet.

The edge-fastening tape can be used for preventing the peeling-off of a coating film protective sheet that protects a coating film of a protected object (an article that has a coating formed by the below-described coating treatment, for example, an automobile body or parts thereof, or a metal plate such as a steel plate or a molded product thereof) subjected to a coating treatment using coating materials of various compositions, such as coating materials based on polyesters, alkyds, melamines, urethanes and combinations thereof. In particular, the edge-fastening tape can be used for preventing the peeling-off of a coating film protective sheet that protects a coating film on an article that is conveyed using a high-speed transfer means, while being exposed to the environment (exposed to air), for example, an automobile and other large articles. Such large articles (typically, automobiles) are most often transferred after being held for several or more days (for example, four days) outdoors for storage, curing or the like. During this outdoor storage period, the surface temperature of the large article (in particular, horizontal portions that are most often the main installation portions for the coating film protective layer, for example, bonnets or the roof of the assembled automobile) can reach about 70° C., even in winter, and rises to about 90° C. in summer. The increase in adhesive strength (in particular, the high-speed peel strength) of the affixed edge-fastening tape can be accelerated by using such temperature increase. Therefore, the edge-fastening tape disclosed herein is particularly useful as an edge-fastening tape for preventing the peeling-off of the coating film protective sheet for automobiles and other articles.

A typical mode of using the edge-fastening tape disclosed herein is shown in FIG. 2. In the example shown in FIG. 2, a coating film protective sheet 20 that has a PSA layer 26 on one surface of a substrate 22 is attached to a coating film 32 of an adherend 30 (for example, an automobile body 30 provided with the coating film 32 coated on a steel plate 34). An edge-fastening tape 10 having the configuration shown in FIG. 1 is adhered so as to straddle an edge portion 20A of the protective sheet 20 and the adherend 30. As a result, the edge portion 20A is affixed to the adherend 30 (in this case, to the coating film 32). The edge-fastening tape 10 is preferably configured such that the peel strength after the passage of time (for example, after holding for 96 h at 80° C.), which is measured according to the below-described high-speed peel test, is higher (preferably, about two or more, more preferably about five or more times higher) than the peel strength of a coating film protective sheet 20 that is measured under the same conditions.

The edge-fastening tape 10 may be used over the entire length (that is, entire circumference of the protective sheet 20) of the outer edge (edge portion 20A) of the protective sheet 20, or on part of the outer edge. Further, the edge-fastening tape 10 may be adhered so that the longitudinal direction thereof is along the outer edge of the protective sheet 20 or so that the longitudinal direction of the edge-fastening tape crosses the outer edge of the protective sheet 20.

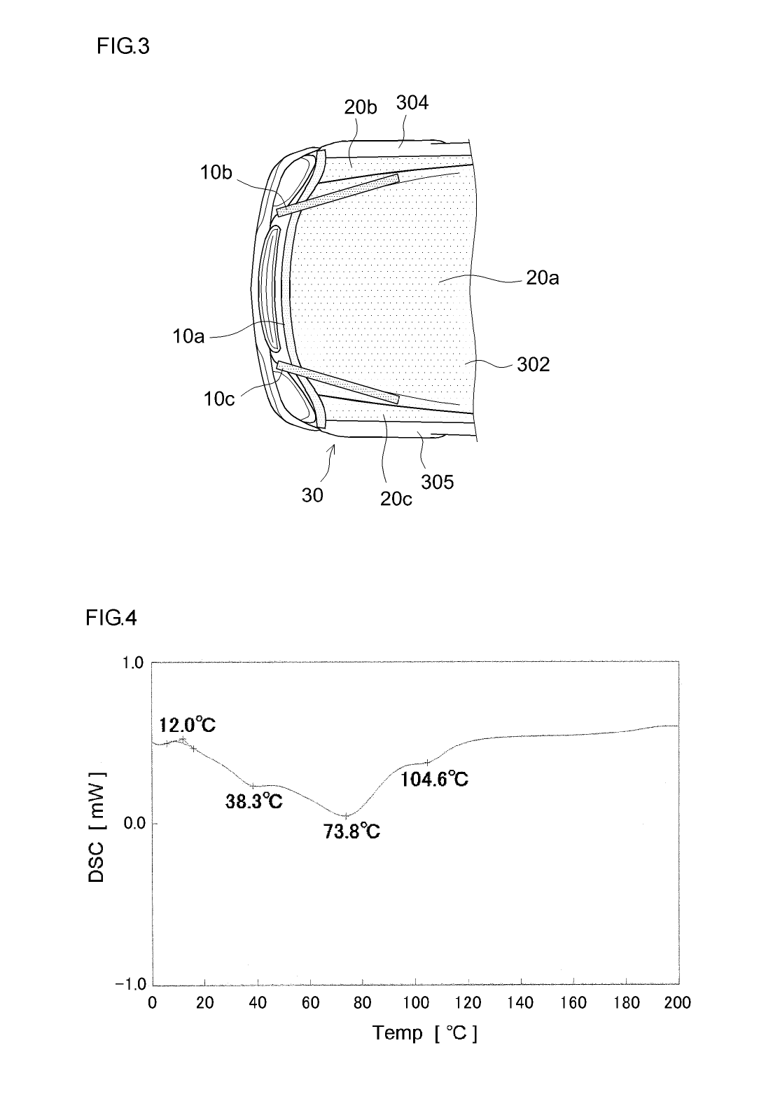

FIG. 3 is a plan view showing an example of a mode in which the front portion of an automobile body 30 is protected by using a coating film protective sheet and an edge-fastening tape. In the example shown in FIG. 3, three coating film protective sheets 20a, 20b, 20c are adhered to portions of a bonnet 302 and side panels 304, 305, and an edge-fastening tape 10a is adhered along the front ends of the coating film protective sheets 20a, 20b, 20c so as to straddle the edge portions of the protective sheets and the surface of the body 30. Further, two edge-fastening tapes 10b, 10c are adhered to cross the front end of the coating film protective sheet 20a (and the edge-fastening tape 10a adhered along the front end) and reach the surface of the body 30 in an upwardly-bulging portion formed in the center of the bonnet 302, the two edge-fastening tapes being adhered along the base of the upwardly-bulging portion.

For example, the edge-fastening tape disclosed herein can exhibit an increase in a high-speed peel strength after holding for 96 h at 80° C. (adhesive strength after the passage of time) by a factor of equal to or greater than about 2 relative to the high-speed peel strength after holding for 30 min at 23° C. in the below-described high-speed peel test (the initial adhesive strength that can serve as an index of the reworking property). An edge-fastening tape configured so that the high-speed peel strength after the aforementioned passage of time is about 3 or more times greater than the initial peel strength is preferred (preferably about 5 or more times greater). With the edge-fastening tape in which the high-speed peel strength increases that significantly with the passage of time, a good reworking property during the adhering (during affixing of the protective sheet) can be combined with excellent performance in preventing the protective sheet from peeling-off during transport (for example, during transport after the protective sheet has been stored and/or cured for several days or longer outdoors).

For example, an edge-fastening tape is preferred that is configured so that the initial high-speed peel strength is within a range of about 0.5 to 10 N/25 mm (preferably about 1 to 5 N/25 mm, typically about 1 to 3 N/25 mm) and the high-speed peel strength after the passage of time is about 2 or more times greater than the initial peel strength and equal to about 3 to 50 N/25 mm (preferably about 20 to 50 N/25 mm, for example, about 20 to 30 N/25 mm). Alternatively, an edge-fastening tape may be configured to have a high-speed peel strength after the passage of time that is about 2 or more times greater than the initial peel strength and is about 5 to 10 N/25 mm. An edge-fastening tape is preferred in which the high-speed peel strength after the passage of time rises by 3 N or more per 25 mm (preferably by 10 N or more per 25 mm, more preferably by 15 N or more per 25 mm, and particularly preferably by 20 N or more per 25 mm). The edge-fastening tape exhibiting the above-described property (peel strength) has an excellent balance of reworking properties and peeling prevention performance and also leaves hardly any adhesive residue or tape marks on the coating film. On the other hand, with an edge-fastening tape, in which the initial peel strength is less than the above-described range, it is difficult to affix the edge portion of the protective sheet to the adherend. Further, with an edge-fastening tape, in which the peel strength after the passage of time is greater than the above-described range, adhesive residue and tape traces can readily appear on the coating film depending on the state of the coating film. It is generally preferred that the initial adhesive strength (for example, the low-speed peel strength) of the edge-fastening tape is set to be equal to or greater than the initial adhesive strength of the coating film protective sheet, which is to be affixed by using the edge-fastening tape.

It is preferred that the difference in the initial adhesive strength (the initial low-speed peel strength) between the edge-fastening tape disclosed herein and the PSA tape formed in the same manner, except that the adhesive strength raising agent has not been disposed, is for example equal to or less than about ±1 N/25 mm (typically equal to or less than about 20%) in the below-described low-speed peel test. The edge-fastening tape having an initial low-speed peel strength of about 2 to 20 N/25 mm (for example, about 5 to 10 N/25 mm) is preferred. Further, it is preferred that the difference in the initial high-speed peel strength with the PSA tape formed in the same manner, except that the adhesive strength raising agent has not been disposed, is for example equal to or less than about ±1 N/25 mm (typically equal to or less than about 30%). Thus, with the edge-fastening tape in which the adhesive strength raising agent initially produces little effect on the peel strength (typically produces essentially no effect on the peel strength), but the function of the adhesive strength raising agent is exhibited with the passage of time (for example, by holding for 96 h at 80° C.) and the peel strength rises significantly, it is possible to combine good reworking properties with excellent peeling prevention properties. The composition of the adhesive strength raising agent, the thickness of the adhesive strength raising agent layer, the PSA composition and the thickness of the PSA layer can be appropriately set to realize the aforementioned properties.

In a preferred mode of the edge-fastening tape disclosed herein, the high-speed peel strength after the passage of time (for 96 h at 80° C.) is about 2 times or more greater (preferably about 3 times or more greater) than that of the PSA tape formed in the same manner, except that the adhesive strength raising agent has not been disposed. The composition of the adhesive strength raising agent, the thickness of the adhesive strength raising agent layer, the PSA composition and the thickness of the PSA layer can be appropriately set to realize the remarkable adhesive strength raising effect by disposing the adhesive strength raising agent in this manner.

Further, the edge-fastening tape preferably exhibits good performance stability during storage (that is, before the tape is used to affix the protective sheet). For example, it is preferred that the variation ratio of the low-speed peel strength relative to the initial adhesive strength is equal to or less than ±10% (more preferably, equal to or less than ±5%, even more preferably equal to or less than ±3%) in the below-described tape storage test (storage for 96 h in an environment at a temperature of 40° C. and a relative humidity of 92%). The edge-fastening tape exhibiting such performance is preferred because of its excellent storage capability.

The reasons are not necessarily clear why the adhesive strength can be effectively increased with the passage of time, while maintaining reworking properties during the adhering, with the edge-fastening tape of the above-described configuration (that is, a configuration in which the prescribed adhesive strength raising agent is disposed between the PSA layer and the support) when the present invention is implemented, but for example the following explanation can be inferred. That is, by admixing the acid-modified polyolefin resin or the chlorinated polyolefin resin into the rubber PSA, the effect of increasing the adhesive strength relative to the coating film can be exhibited due to the interaction of polar functional groups of the resin and polar functional groups of the coating film. However, with an edge-fastening tape having a PSA layer, in which the modified polyolefin resin (acid-modified polyolefin resin and/or chlorinated polyolefin resin) has been admixed with the rubber PSA in advance, good reworking properties during the adhering cannot be realized together with a sufficient adhesive strength after the passage of time.

In the edge-fastening tape disclosed herein, a modified polyolefin resin with a prescribed DSC characteristic is disposed between the PSA layer and the support. The modified polyolefin resin has a high chemical affinity of the polyolefin chain located in the skeleton thereof to the rubber PSA (preferably, a polyisobutylene PSA) and has the aforementioned DSC characteristic. As a result, the resin can easily diffuse into the PSA layer of the edge-fastening tape. By causing the modified polyolefin resin to diffuse into the PSA, it is possible to increase the adhesive strength of the edge-fastening tape by the interaction of the polar functional groups of the modified polyolefin resin, which have reached the vicinity of the PSA surface layer, and the polar functional groups of the coating film. Thus, a modified polyolefin resin having the aforementioned DSC characteristic can effectively function as an adhesive strength raising agent.

When an acid-modified polyolefin resin is used as an adhesive strength raising agent, advantageous results can be obtained by specifically selecting and using an acid-modified polyolefin resin that does not have a dominant endothermic peak corresponding to the softening temperature in the DSC measurement. The reason therefor will be described below. That is, in an acid-modified polyolefin resin, in which a peak corresponding to the softening temperature is apparent as a dominant peak, a major portion of the resin moves swiftly with high mobility near the softening temperature. Therefore, for example, since the diffusion of the acid-modified polyolefin resin is not sufficiently advanced by the softening temperature and the thermal history of the edge-fastening tape, the adhesive strength raising effect is not obtained. Another possible inconvenience is that the diffusion capability of the acid-modified polyolefin resin will be too high and the initial adhesive strength will be increased (the reworking properties will be degraded). On the other hand, in an acid-modified polyolefin resin that does not have a dominant endothermic peak, a state in which a portion with high mobility (that is, easily diffusible into the PSA) is mixed at a certain ratio with a portion with low mobility can be maintained over a relatively wide temperature range. This is apparently why the adhesive strength raising effect is realized at an appropriate timing.

When a chlorinated polyolefin resin is used as the adhesive strength raising agent, advantageous results can be obtained by specifically selecting and using a resin having the prescribed Tg in the DSC measurement. When the Tg of the chlorinated polyolefin resin is too high, the diffusion capability into the PSA layer becomes too high and the initial adhesive strength can be increased. Particularly good results can be obtained by selecting a chlorinated polyolefin resin that does not have a dominant peak in the DSC measurement, similar to the acid-modified polyolefin resin. The reasons therefor are apparently similar to those discussed with respect to the acid-modified polyolefin resin.

Several examples relating to the present invention will be described below, but the present invention is not intended to be limited to these examples. In the explanation below, “parts” and “%” are based on the weight of the non-volatiles, unless specifically stated otherwise.

The weight-average molecular weight described in the examples below is a value calculated as polystyrene that is obtained by performing measurements with a GPC device (manufactured by Waters Co., model “GPC-150c”, type “plus”) under the following conditions.

### [Conditions for Measuring the Weight-Average Molecular Weight]

Sample solution: 0.10% (w/w) o-dichlorobenzene solution
Sample injection amount: 500 μL
Transfer phase: o-dichlorobenzene
Flow velocity: 1.0 mL/min
Column temperature: 140° C.
Column: produced by Toso KK, type “GMH₆-HT 30 cm” (two columns) and “GMH₆-HTL 30 cm” (two columns)
Detector: differential refractometer

A differential scanning calorimeter, model “6220”, manufactured by SII NanoTechnology Inc. was also used for the DSC measurements. The measurement conditions are described below.

### [DSC Measurement Conditions]

Sample preparation: about 7 mg of the measurement object was weighed, dried for 20 min at 100° C. and then sealed in an aluminum container.
Measurement temperature range: −10° C. to 200° C. (Examples 1 to 3), −40° C. to 200° C. (Examples 5 to 9, 11, and 12).
Temperature program: the sample was heated from a lower end temperature to an upper end temperature of the measurement temperature range at a temperature increase rate of 10° C./min and then rapidly cooled. The values obtained when the sample was thereafter heated again from the lower end temperature to the upper end temperature of the measurement temperature range at a temperature increase rate of 10° C./min were taken as the measurement data. Thus, the DSC measurements were performed twice continuously and the DSC measurement data were acquired during the second increase in temperature.

### Example 1

A support molding material including 38 parts of propylene homopolymer (produced by Japan Polypropylene Corp., trade name “Novatec PP FY4”), 37 parts of ethylene-propylene block copolymer (produced by Japan Polypropylene Corp., trade name “Novatec PP BC3F”), 15 parts of linear low-density polyethylene (LLDPE) (produced by Japan Polyethylene Corp., trade name “Kernel KF380”), 10 parts of rutile-type titanium dioxide (manufactured by Ishihara Sangyo Kaisha, Ltd., trade name “TIPAQUE CR-95”) and 0.2 parts of a photostabilizer (manufactured by Ciba Specialty Chemicals KK, trade name “Chimassorb 944”) was melt kneaded in a film forming machine and extruded from a T-die to mold a support (polyolefin resin film) having a thickness of 40 μm.

A chlorine-free acid-modified polyolefin resin (manufactured by Nippon Paper Chemicals Co., Ltd., trade name “Auroren 100T”) was dissolved in an organic solvent to an appropriate concentration in order to prepare an adhesive strength raising agent solution. The solution was coated using a Meyer bar #10 on one surface of the support obtained in the above-described manner and dried to form an adhesive strength raising agent layer having a thickness of about 1 μm on one surface of the support.

A PSA composition was prepared in which 75 parts of polyisobutylene (manufactured by ExxonMobil Corp., trade name “Vistanex MML-100”) and 25 parts of polyisobutylene (manufactured by BASF, trade name “Oppanol B12SFN”) were dissolved in an organic solvent. The composition was coated on top of the adhesive strength raising agent layer and dried to form a polyisobutylene PSA layer having a thickness of 10 μm. The PSA sheet of Example 1 was thus fabricated.

### Example 2

A PSA sheet of Example 2 was fabricated in the same manner as in Example 1, except that the resin material used in the preparation of the adhesive strength raising agent solution was changed to a chlorine-free acid-modified polyolefin resin “Auroren 150T” manufactured by Nippon Paper Chemicals Co., Ltd.

### Example 3

A PSA sheet of Example 3 was fabricated in the same manner as in Example 1, except that the resin material used in the preparation of the adhesive strength raising agent solution was changed to a chlorine-free acid-modified polyolefin resin “Auroren 150MX” manufactured by Nippon Paper Chemicals Co., Ltd.

### Example 4

A PSA sheet of Example 4 was fabricated in the same manner as in Example 1, except that the adhesive strength raising agent layer was not formed.

### Example 5

A substrate molding material identical to that used in Example 1 was melt kneaded in a film forming machine and extruded from a T-die of the molding machine to mold a substrate (polyolefin resin film) having a thickness of 35 μm.

A chlorine-free acid-modified polyolefin resin (manufactured by Toyo Kasei Kogyo Co., Ltd., trade name “Hardlen MP-200”) was dissolved in an organic solvent to an appropriate concentration in order to prepare an adhesive strength raising agent solution. One surface of the support obtained in the above-described manner was subjected to a corona discharge treatment and then coated with the adhesive strength raising agent solution by using a Meyer bar #5 and dried to form an adhesive strength raising agent layer having a thickness of 0.03 to 0.15 μm on one surface of the support.

A peptizing treatment was performed (see Japanese Patent No. 3878700) by adding benzoyl peroxide to an n-heptane solution of polyisobutylene (manufactured by BASF, trade name “Oppanol B80”). As a result, a solution containing peptized polyisobutylene with a weight-average molecular weight of 55×10⁴ (as polystyrene) was obtained. A total of 0.5 parts of an ultraviolet radiation absorber (manufactured by Ciba Specialty Chemicals KK, trade name “TINUVIN 326”) a photostabilizer (manufactured by Ciba Specialty Chemicals KK, trade name “Chimassorb 944”), and 0.3 parts of a tackifier (manufactured by Sumitomo Durez KK, trade name “Durez 19900”) were added to 100 parts (based on solid content) of the solution in order to prepare a PSA composition. The PSA composition was coated on top of the adhesive strength raising agent layer and dried to form a polyisobutylene PSA layer having a thickness of 10 μm. The PSA sheet of Example 5 was thus fabricated.

### Example 6

A PSA sheet of Example 6 was fabricated in the same manner as in Example 5, except that the resin material used in the preparation of the adhesive strength raising agent solution was changed to “Hardlen MP-300” (chlorine-free acid-modified polyolefin resin) manufactured by Toyo Kasei Kogyo Co., Ltd.

The following evaluation tests were conducted with respect to the PSA sheets fabricated in Examples 1 to 6.

### [Initial Adhesive Properties]

A PSA sheet of each example was cut into bands having a width of 25 mm and a length of 150 mm in order to prepare test specimens. A coating film obtained by coating an acid epoxy cross-linked coating material (manufactured by Kansai Paint KK, trade name “KINO1210TW”) on a steel plate was degreased with hexane of JIS 1 grade, and the test specimens were adhered to the coating film in a standard environment adjusted to a temperature of 23±2° C. and a humidity of 50±15% RH. The test specimens were pressure adhered by reciprocally moving a 2 kg rubber roller conforming to JIS Z 237:2000 at a speed of 3 m/min. Holding for 30 min in the standard environment was performed after the adhering and then a low-speed peel test and a high-speed peel test were performed under the following conditions.

Low-speed peel test: the low-speed peel strength [N/25 mm] was measured at a peel speed (crosshead speed) of 300 mm/min, a peel angle of 180° and a peel length of 100 mm by using a tensile testing machine Autograph AG-10G manufactured by Shimazu Corp. The measurements were performed three times. An average value is shown as the measurement value in Table 1.

High-speed peel test: the high-speed peel strength [N/25 mm] was measured at a peel speed of 30 m/min, a peel angle of 180° and a peel length of 100 mm by using a high-speed peel testing machine TE-701 manufactured by Tester Sangyo KK. The measurements were performed three times. An average value is shown as the measurement value in Table 1.

[Adhesive Properties After the Passage of Time]

Test sheets in which the test specimens were adhered to the coating film in the same manner as in the above-described adhesive properties test were held for 96 h in a constant temperature oven (model “PH211” manufactured by ESPEC Co.) that was adjusted to 80±2° C. The test sheets were then removed from the constant temperature oven and held for 2 h in the above-described standard environment. The low-speed peel strength [N/25 mm] and the high-speed peel strength [N/25 mm] were then measured in the same manner as when the initial adhesive properties were determined. The measurements were performed three times. An average value is shown as the measurement value in Table 1.

[Adhesive Residue]

After the heating, the surfaces (locations where the test specimens were adhered) of the test sheets (coating films) used for the above-described adhesive properties test were visually observed and the results were estimated in the following manner.

Good: no residue could be visually observed.

Poor: residue could be visually observed.

“Good” test results were obtained in all of the Examples 1 to 6.

[Tape Marks]

After the heating, the test sheets used for the above-described adhesive properties test were heated for 1 h at 80° C., were removed to the standard environment and were left for 1 h. The coating film surfaces (locations where the test specimens were adhered) were then visually observed and the results were estimated in the following manner.

Good: no tape marks could be visually observed.

Poor: tape marks could be visually observed.

“Good” test results were obtained for all of the Examples 1 to 6.

[Tape Storage Ability]

The PSA sheets fabricated in Examples 1 to 4 were held for 96 h in a constant temperature oven (model “PR-3K” manufactured by ESPEC Co.) that was adjusted to a temperature of 40±2° C. and a humidity of 92±3% RH, then removed to the standard environment (23±2° C., 50±15% RH) and held for 2 h. The PSA sheets were then cut into bands having a width of 25 mm and a length of 150 mm and the low-speed peel strength [N/25 mm] was measured in the same manner as in the initial adhesive property test by using the test specimens thus obtained. The measurements were performed three times. An average value is shown as the measurement value in Table 1.

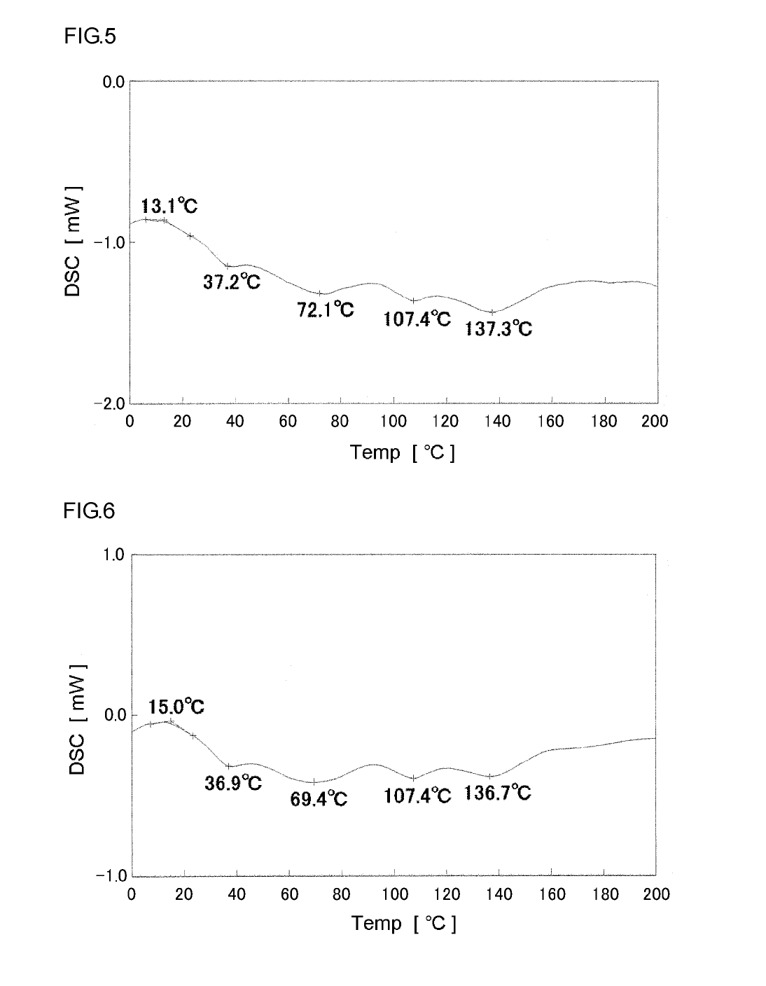

The DSC measurements were performed under the above-described conditions with respect to the adhesive strength raising agent (acid-modified polyolefin resin) used in each example. The data obtained (DSC measurement charts) are shown in FIGS. 4 to 6 for Examples 1 to 3 and in FIGS. 7 and 8 for Examples 5 and 6. A glass transition temperature (Tg) [° C.] and the temperature [° C.] of each endothermic peak determined from the DSC measurement results are also shown in FIGS. 4 to 8.

As shown in FIGS. 4 to 6, with all of the adhesive strength raising agents used in Examples 1 to 3, the endothermic peaks corresponding to the softening temperature were indistinct or broad (represented by “ND” in Table 1), rather than dominant. By contrast, as shown in FIGS. 7 and 8, with the adhesive strength raising agents used in Examples 5 and 6, dominant endothermic peaks corresponding to the softening temperature (both of these peaks correspond to maximum endothermic peaks) were present in locations equal to or above 80° C. (more specifically, equal to or higher than 100° C.).

The aforementioned test results and the DSC measurement results are presented in Table 1. Since the results relating to adhesive residue and tape marks were “Good” in all of the Examples 1 to 6, these results are not shown in the table.

TABLE 1

| | | Example | Example | Example | Example | Example | Example |
|---|---|---|---|---|---|---|---|
| | | 1 | 2 | 3 | 4 | 5 | 6 |
| Low-speed | Initial | 7.7 | 7.0 | 7.9 | 7.8 | 6.0 | 5.7 |
| peeling at 300 | (23° C. , 30 | | | | | | |
| mm/min | min) | | | | | | |
| [N/25 mm] | After the | 9.9 | 10.3 | 10.5 | 10.2 | 6.1 | 5.5 |
| | passage of | | | | | | |
| | time (80° C. , | | | | | | |
| | 96 h) | | | | | | |
| High-speed | Initial | 1.8 | 1.3 | 1.5 | 1.8 | 1.2 | 1.3 |
| peeling at 30 | (23° C. , 30 | | | | | | |
| m/min [N/25 | min) | | | | | | |
| mm] | After the | 26.4 | 25.8 | 26.3 | 5.3 | 2.1 | 2.4 |
| | passage of | | | | | | |
| | time (80° C. , | | | | | | |
| | 96 h) | | | | | | |
| Tape storage ability [N/25 | | 7.5 | 6.9 | 7.7 | 7.7 | — | — |
| mm] | | | | | | | |
| Softening temperature [° C.] | | ND | ND | ND | | 103 | 131 |
| Tg [° C.] | | 12 | 13 | 15 | | − 16 | − 8 |

As shown in Table 1, in Examples 1 to 3 in which an acid-modified polyolefin resin having no dominant endothermic peak in the DSC measurement was used as the adhesive strength raising agent, the initial adhesive strength was the same as in Example 4 (example in which the adhesive strength raising agent was not used) in both the low-speed peeling test and the high-speed peel test. This result supports the conclusion that the PSA sheets used in Examples 1 to 3 exhibited good reworking properties during adhering. Further, with the PSA sheets of Examples 1 to 3, the high-speed peel strength after the passage of time was high (about 5 or more times, and even 10 or more times the initial high-speed peel strength). However, in Example 4 in which the adhesive strength raising agent was not used and in Examples 5 and 6 in which the acid-modified polyolefin resins were used that had a dominant endothermic peak corresponding to the softening temperature in the DSC measurement, the effect of the significant increase in the high-speed peel strength due to the passage of time was not obtained.

With all of the PSA sheets of Examples 1 to 4, the initial low-speed peel strength measured in the tape storage ability test was at the same level as before the storage (98 to 99% of that before the storage) and good tape storage ability was confirmed.

### Example 7

The resin material used to prepare the adhesive strength raising agent solution was changed to “Hardlen DX-526” (chlorinated polyolefin resin) manufactured by Toyo Kasei Kogyo Co., Ltd. In other aspects, the PSA sheet of Example 7 was fabricated in the same manner as in Example 5.

### Example 8

The resin material used to prepare the adhesive strength raising agent solution was changed to “Hardlen CY-9124” (chlorinated polyolefin resin modified with maleic anhydride) manufactured by Toyo Kasei Kogyo Co., Ltd. In other aspects, the PSA sheet of Example 8 was fabricated in the same manner as in Example 5.

### Example 9

The resin material used to prepare the adhesive strength raising agent solution was changed to “Superclone 851” (chlorinated polyolefin resin modified with maleic anhydride) manufactured by Nippon Paper Chemicals Co., Ltd. In other aspects, the PSA sheet of Example 9 was fabricated in the same manner as in Example 5.

### Example 10

The PSA sheet of Example 10 was fabricated in the same manner as in Example 5, except that no adhesive strength raising agent layer was formed.

### Example 11

The resin material used to prepare the adhesive strength raising agent solution was changed to “Hardlen 14-ML” (chlorinated polyolefin resin modified with maleic anhydride) manufactured by Toyo Kasei Kogyo Co., Ltd. In other aspects, the PSA sheet of Example 11 was fabricated in the same manner as in Example 5.

### Example 12

The resin material used to prepare the adhesive strength raising agent solution was changed to “Hardlen 14-LLB” (chlorinated polyolefin resin) manufactured by Toyo Kasei Kogyo Co., Ltd. In other aspects, the PSA sheet of Example 12 was fabricated in the same manner as in Example 5.

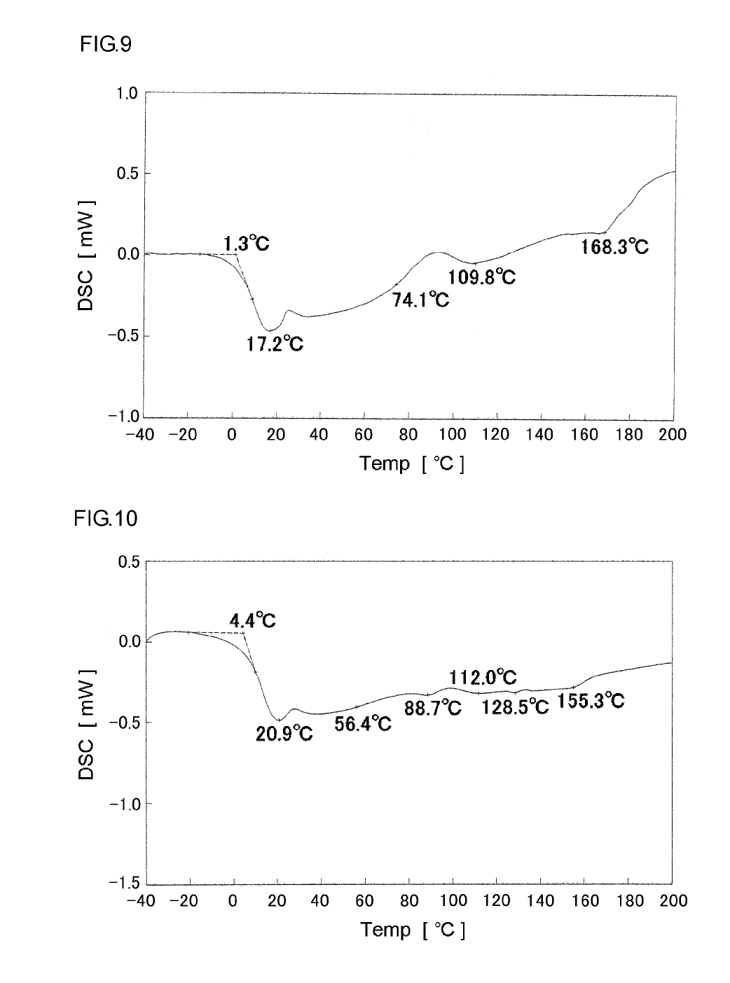

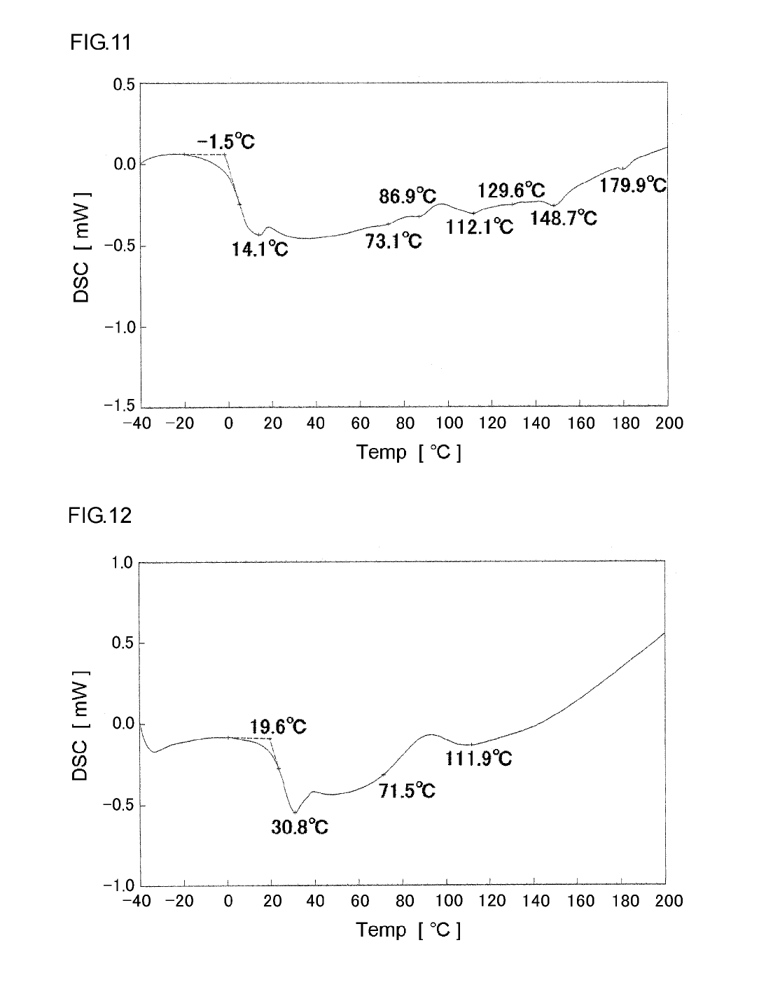

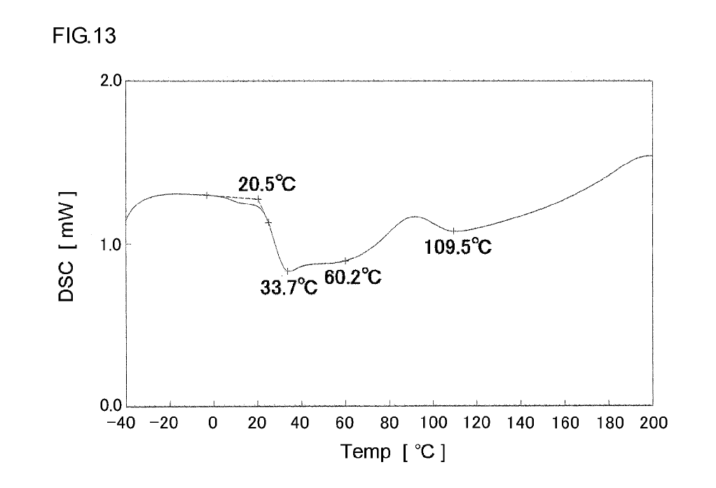

Evaluation tests similar to those performed with respect to the PSA sheets of Examples 1 to 6 were also performed with respect to the PSA sheets fabricated in Examples 7 to 12. DSC measurements were also performed under the below-described conditions with respect to the adhesive strength raising agents (chlorinated polyolefin resins) used in these examples. The data obtained (DSC measurement charts) are shown together with the glass transition temperature (Tg) [° C.] and the temperature [° C.] of each endothermic peak in FIGS. 9 to 11 with respect to Examples 7 to 9 and in FIGS. 12 and 13 with respect to Examples 11 and 12.

As shown in FIGS. 9 to 11, all of the adhesive strength raising agents used in Examples 7 to 9 had a Tg below 10° C. (equal to or above −5° C. and below 10° C., more specifically, equal to or above −5° C. and equal to or below 5° C.). As shown in FIGS. 12 and 13, all of the adhesive strength raising agents used in Examples 11 and 12 had a Tg of equal to or above 10° C. (more specifically, equal to or above 15° C. and even equal to or above about 20° C.). All of the adhesive strength raising agents used in these Examples 7 to 9 and Examples 11 and 12 had a non-dominant (indistinct or broad) endothermic peak corresponding to the softening temperature.

Various evaluation tests were performed in the same manner as described above with respect to the PSA sheets of Examples 7 to 12. The results obtained are shown together with the DSC measurement results in Table 2. Since the results relating to adhesive residue and tape marks were “Good” in all of the Examples 7 to 12, these results are not shown in the table.

TABLE 2

| | | Example | Example | Example | Example | Example | Example |
|---|---|---|---|---|---|---|---|
| | | 7 | 8 | 9 | 10 | 11 | 12 |
| Low-speed | Initial | 5.7 | 6.2 | 6.1 | 6.0 | 6.5 | 6.4 |
| peeling at | (23° C. , 30 | | | | | | |
| 300 mm/min | min) | | | | | | |
| [N/25 mm] | After the | 6.6 | 6.4 | 8.1 | 6.7 | 6.5 | 6.1 |
| | passage of | | | | | | |
| | time (80° C. , | | | | | | |
| | 96 h) | | | | | | |
| High-speed | Initial | 1.0 | 1.2 | 1.2 | 1.3 | 1.2 | 1.3 |
| peeling at | (23° C. , 30 | | | | | | |
| 30 m/min [N/25 | min) | | | | | | |
| mm] | After the | 5.5 | 3.8 | 9.0 | 2.2 | 2.5 | 2.6 |
| | passage of | | | | | | |
| | time (80° C. , | | | | | | |
| | 96 h) | | | | | | |

| | | | | | |
|---|---|---|---|---|---|
| Softening temperature [° C.] | 17 | 21 | 14 | 31 | 34 |
| Tg [° C.] | 1 | 4 | − 2 | 20 | 21 |

As shown in Table 2, in Examples 7 to 9 in which a chlorinated polyolefin resin having a Tg below 10° C. was used as the adhesive strength raising agent, the initial adhesive strength was the same as in Example 10 (example in which the adhesive strength raising agent was not used) in both the low-speed peel test and the high-speed peel test. This result supports the conclusion that the PSA sheets used in Examples 7 to 9 exhibited good reworking properties during adhering. Further, with the PSA sheets of Examples 7 to 9, the high-speed peel strength after the passage of time was high (about 3 or more times the initial high-speed peel strength). However, in Example 10 in which the adhesive strength raising agent was not used and in Examples 11 and 12 in which the chlorinated polyolefin resins having a Tg above 15° C. were used, the effect of the significant increase in the high-speed peel strength with the passage of time was not obtained.

The present invention is described in detail hereinabove, but the invention is not limited to the above-described embodiments and the invention disclosed herein includes various modifications and changes of the aforementioned specific examples.

1. An edge-fastening tape suitable for affixing an edge portion of a coating film protective sheet, which has a pressure-sensitive adhesive layer disposed on a substrate, to an adherend, the tape comprising:
a sheet-shaped support; and
a rubber pressure-sensitive adhesive layer provided on one surface of the support, wherein
an adhesive strength raising agent that raises an adhesive strength of the pressure-sensitive adhesive layer with the passage of time is disposed between the pressure-sensitive adhesive layer and the support, and
the adhesive strength raising agent comprises an acid-modified polyolefin resin, which does not exhibit a dominant endothermic peak corresponding to a softening temperature in a DSC measurement in which the temperature is raised from −10° C. to 200° C. at a rate of 10° C./min.

2. The edge-fastening tape according to claim 1, wherein the adhesive strength raising agent is an acid-modified polyolefin resin, which includes an acid-modified polyolefin chain that has been graft modified by an acid.

3. The edge-fastening tape according to claim 2, wherein the acid is maleic anhydride.

4. The edge-fastening tape according to claim 1, wherein the adhesive strength raising agent is a chlorine-free acid-modified polyolefin resin.

5. The edge-fastening tape according to claim 1, wherein a weight-average molecular weight, when calculated as polystyrene, of the acid-modified polyolefin resin is equal to or greater than 3×10⁴.

6. An edge-fastening tape suitable for affixing an edge portion of a coating film protective sheet, which has a pressure-sensitive adhesive layer disposed on a substrate, to an adherend, the tape comprising:
a sheet-shaped support; and
a rubber pressure-sensitive adhesive layer provided on one surface of the support, wherein
an adhesive strength raising agent that raises an adhesive strength of the pressure-sensitive adhesive layer with the passage of time is disposed between the pressure-sensitive adhesive layer and the support, and
the adhesive strength raising agent comprises a chlorinated polyolefin resin, which exhibits a glass transition temperature below 10° C. as determined by a DSC measurement in which the temperature is raised from −10° C. to 200° C. at a rate of 10° C./min.

7. The edge-fastening tape according to claim 6, wherein a weight-average molecular weight, when calculated as polystyrene, of the chlorinated polyolefin resin is equal to or greater than 3×10⁴.

8. The edge-fastening tape according to claim 6, wherein the adhesive strength raising agent is disposed on a surface of the support as a layer having a thickness of 0.02 μm to 3 μm.

9. The edge-fastening tape according to claim 6, wherein the support is a polyolefin resin sheet that includes one of: (i) solely a polypropylene resin as a resin component and (ii) a polypropylene resin and a polyethylene resin as resin components.

10. The edge-fastening tape according to claim 6 wherein the pressure-sensitive adhesive layer is a polyisobutylene pressure-sensitive adhesive layer.

11. The edge-fastening tape according to claim 6, wherein the adherend is a vehicle body.

12. A method for preventing a coating film protective sheet, which includes a pressure-sensitive adhesive layer disposed on a substrate, from peeling off from a coating film disposed on an adherend surface, comprising:
attaching the protective sheet to the adherend surface in order to protect the coating film, and
affixing an edge portion of the protective sheet to the adherend surface by adhering the edge-fastening tape according to claim 1 so as to straddle the edge portion of the protective sheet and the adherend surface.

13. A method for preventing a coating film protective sheet, which includes a pressure-sensitive adhesive layer disposed on a substrate, from peeling off from a coating film disposed on an adherend surface, comprising:
attaching the protective sheet to the adherend surface in order to protect the coating film, and
affixing an edge portion of the protective sheet to the adherend surface by adhering the edge-fastening tape according to claim 6 so as to straddle the edge portion of the protective sheet and the adherend surface.

14. The edge-fastening tape according to claim 1, wherein the adhesive strength raising agent is disposed on a surface of the support as a layer having a thickness of 0.02 μm to 3 μm.

15. The edge-fastening tape according to claim 1, wherein the support is a polyolefin resin sheet that includes one of: (i) solely a polypropylene resin as a resin component and (ii) a polypropylene resin and a polyethylene resin as resin components.

16. The edge-fastening tape according to claim 1, wherein the pressure-sensitive adhesive layer comprises polyisobutylene.

17. The edge-fastening tape according to claim 14, wherein the adhesive strength raising agent comprises a chlorine-free acid-modified polyolefin resin.

18. An adhesive tape comprising:
a flexible support,
an adhesive strength raising agent disposed on the flexible support, and
a rubber pressure-sensitive adhesive layer disposed on the adhesive strength raising agent,
wherein the rubber pressure-sensitive adhesive layer and the adhesive strength raising agent have the property that at least a part of the adhesive strength raising agent is diffusable into the rubber pressure-sensitive adhesive layer with the passage of time and causes the adhesive strength of the rubber pressure-sensitive adhesive layer to rise, and
the adhesive strength raising agent comprises a polyolefin resin selected from the group consisting of: an acid-modified polyolefin resin, which does not exhibit a dominant endothermic peak corresponding to a softening temperature in a DSC measurement in which the temperature is raised from −10° C. to 200° C. at a rate of 10° C./min, and a chlorinated polyolefin resin, which exhibits a glass transition temperature below 10° C. as determined by a DSC measurement in which the temperature is raised from −10° C. to 200° C. at a rate of 10° C./min.

19. The adhesive tape according to claim 18, wherein:
the support comprises at least 50% by mass of polypropylene and has a thickness of about 20 μm to 100 μm,
the rubber pressure-sensitive adhesive layer comprises polyisobutylene and has a thickness of about 2 μm to 30 μm, the polyisobutylene having a weight-average molecular weight of about 10×10⁴ to 150×10⁴,
the adhesive strength raising agent has a thickness of about 0.02 μm to 10 μm, a weight-average molecular weight, when calculated as polystyrene, of the acid-modified or chlorinated polyolefin resin is equal to or greater than 3×10⁴ and less than about 20×10⁴ and at least one of the following conditions is satisfied: (i) the chlorinated polyolefin resin has a glass transition temperature above about −5° C. and (ii) the acid-modified polyolefin resin is chlorine-free and has been graft-modified with an α- or β-unsaturated carboxylic acid or an anhydride thereof, and
the tape has an initial high-speed peel strength of about 0.5 to 10 N/25 mm and the initial high-speed peel strength of the tape increases by a factor of at least 2 after subjecting the tape to a temperature of 80° C. for 96 hours.

20. A method for securing an edge portion of a protective sheet, which comprises a pressure-sensitive adhesive layer disposed on a substrate, so as to prevent it from peeling off from a painted surface, comprising:
adhering the pressure-sensitive adhesive layer of the protective sheet to the painted surface, and
adhering the adhesive tape according to claim 19 so as to overlap the edge portion of the protective sheet and the painted surface.
